(19) United States
(12) Patent Application Publication
(10) Pub. No.: US 2009/0000749 A1
(43) Pub. Date: Jan. 1, 2009

(54) VENETIAN BLIND OR THE LIKE AND DRIVE UNIT THEREFOR

(75) Inventors: Thomas Amann, Grafenhausen (DE); Frank Thiele, Bonndorf (DE); Klaus Pfendler, Bonndorf (DE)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/137,586

(22) Filed: Jun. 12, 2008

(30) Foreign Application Priority Data
Jun. 27, 2007 (EP) 07301154.6

(51) Int. Cl. E06B 9/17; E06B 9/32

(52) U.S. Cl. 160/168.1 P; 160/310

(57) ABSTRACT

The invention relates to a drive unit for a Venetian blind or the like for inserting into a head rail, including an electric motor and output shafts at both ends driven via gear, where the electric motor is combined with components serving for acoustically damping and uncoupling, that are shaped such that they are insertable into the head rail together with the electric motor as well as to a Venetian blind or the like as such.

### BACKGROUND OF THE INVENTION

The invention is based on a priority application EP 07301154.6 which is hereby incorporated by reference.

The invention relates to a drive unit for a Venetian blind or the like for inserting into a head rail, including an electric motor and output shafts at both ends driven via gear.

Further embodiments of the invention are a Venetian blind or the like including a drive unit installed in a head rail and driving the Venetian blind or the like at both ends of the head rail.

Electrically driven Venetian blinds, roller shutters, cinema screens, and other objects to be wound on to and off a tube mostly are used in rooms where people stay. Often they are operated automatically, and at least then their unexpected operation is considered to be disturbing in consequence of their noise.

It is to be mentioned that not in every application the objects as such are wound on to and off a tube but only drive parts thereof. This does not change the problem.

It is known to acoustically isolate the drives by enclosing the head rails with suitable material. This necessitates additional installation efforts.

### OBJECT OF THE INVENTION

The technical problem thus is to reduce the installation efforts.

### SUMMARY OF THE INVENTION

According to the invention this problem is solved by a drive unit for a Venetian blind or the like for inserting into a head rail, including an electric motor and output shafts at both ends driven via gear, wherein the electric motor is combined with components serving for acoustically damping and uncoupling, that are shaped such that they are insertable into the head rail together with the electric motor.

The invention further relates a Venetian blind or the like including a drive unit installed in a head rail and driving the Venetian blind or the like at both ends of the head rail, wherein the drive unit includes an electric motor that is combined with components serving for acoustically damping and uncoupling, that are shaped such that they are insertable into the head rail together with the electric motor.

The solution mainly is based on measures that are taken before the installation onsite.

Further details and embodiments are to be found in the subclaims and in the following description.

### BRIEF DESCRIPTION OF THE DRAWINGS

In the following the invention will be described with the aid of the accompanying drawing.

FIG. 1 shows a simplified longitudinal section through a drive unit according to the invention.

FIG. 2 shows a more detailed view of a drive unit according to the invention.

### DETAILED DESCRIPTION OF THE DRAWINGS

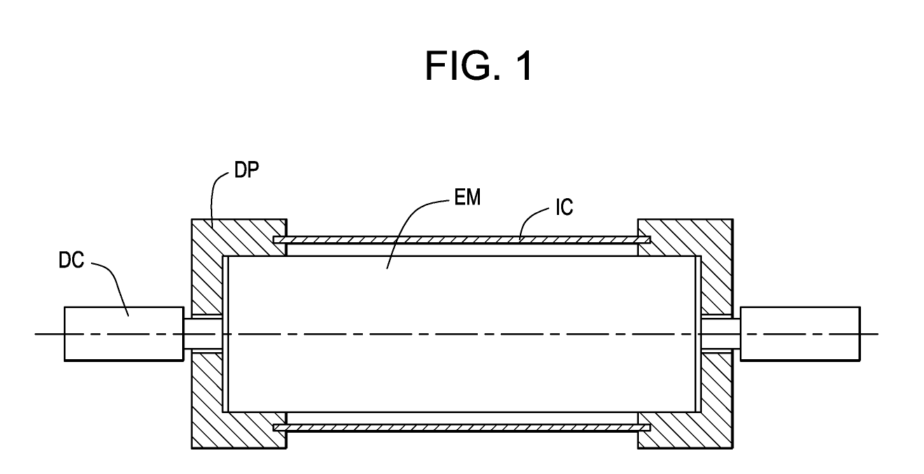

Based on FIG. 1 now the principle is described:

FIG. 1 shows a simplified longitudinal section through a drive unit according to the invention. We see an electric motor EM, an isolating coating IC, two damping plugs DP, and two damping clutches DC.

The electric motor EM here is representative for the proper motor as well as for the gear or gears, a brake, if necessary, and the bearings.

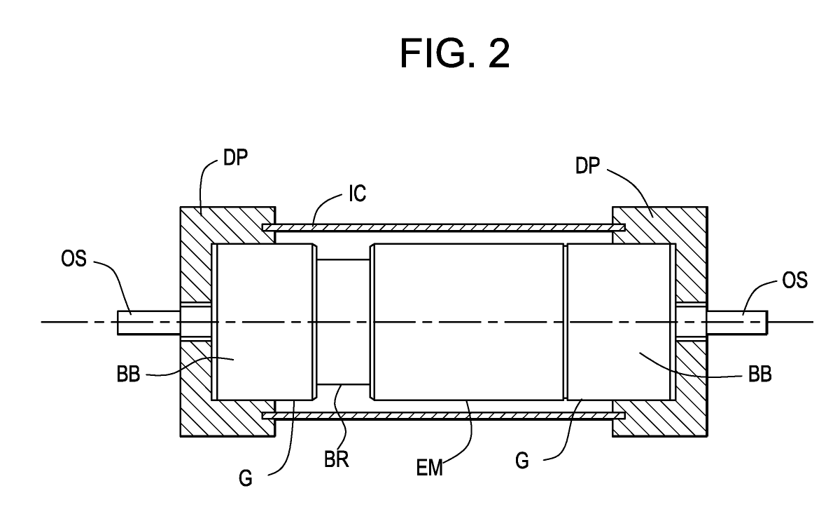

Electric motors for such applications mostly are AC-induction motors for short-time operation with mounted gearboxes. It is cheaper to have gears at both sides of the motor. But it is also known to use only one gear in combination with a hollow shaft through the motor. Depending on the kind of gear or gears also an electromechanical brake may be necessary. At both ends at least one bearing each is necessary. Normally ball bearings are used. A view with more such details is to be seen in FIG. 2.

Back to figure where we see three independent measures for acoustically isolating the motor:
The isolating coating IC is surrounding the electric motor EM in a somehow concentric form. In FIG. 1 this is shown like a plate, but it is evident, that it can have as much isolating material, normally isolating foam, as possible. The inner shape of this coating IC may fit to the outer shape of the electric motor, often being a circular cylinder. This can be seen in FIG. 2. The outer shape may fit to the inner shape of an expected head rail, often being similar to a square. Depending on the expected way of installation into the head rail, this part may leave a small free room between the isolating coating and the expected head rail for inserting the drive by pushing it into the head rail. This may reduce the frictional resistance.
Damping plugs DP are attached at both ends of the electric motor EM. They have a part surrounding the motor similar to the isolating coating and a disk part for closing the isolation. With respect to the shape and the material similar considerations apply as for the isolating coating IC. Preferably these damping plugs DP have an outer shape to slide into the head rail.
Acoustically damping clutches DC interrupt the metal shafts and thus hinder propagation of acoustic noise. Their shape and material of course have to guarantee the transfer of the moment of force.

As can be seen in FIG. 1, and as well in FIG. 2, the damping plugs DP and the isolating coating IC have meshing elements to interlock.

FIG. 2 shows the given example of the drive unit in more detail. We see the proper electric motor EM combined with a brake BR, two gears G at both sides of the motor EM, two output shafts OS, each kept by ball bearings BB, as well as the already described isolating coating IC and the damping plugs DP. The damping clutches from FIG. 1 are not to be seen here.

1. A drive unit for a Venetian blind or the like for inserting into a head rail, including an electric motor and output shafts at both ends driven via gear, wherein the electric motor is combined with components serving for acoustically damping and uncoupling, that are shaped such that they are insertable into the head rail together with the electric motor.

2. The drive unit according to claim 1, characterized in, that the electric motor is surrounded by an acoustically damping element.

3. The drive unit according to claim 1, characterized in, that at the ends of the electric motor acoustically damping plugs are attached.

4. The drive unit according to claim 1, characterized in, that the output shafts are coupled to the gear or gears by means of acoustically damping clutches.

5. A Venetian blind or the like including a drive unit installed in a head rail and driving the Venetian blind or the like at both ends of the head rail, wherein the drive unit is designed according to claim 1.
